(19) United States
(12) Patent Application Publication
(10) Pub. No.: US 2002/0140312 A1
(43) Pub. Date: Oct. 3, 2002

(54) Method for manufacturing an armature of an internal rotor type electric machine and the armature manufactured by such method

(76) Inventors: Shinji Ikeda, Kiryu-shi (JP); Hitoshi Ishii, Kiryu-shi (JP); Shinji Shimizu, Kiryu-shi (JP); Hiroshi Kikuchi, Kiryu-shi (JP); Toshimi Abukawa, Kiryu-shi (JP)

Correspondence Address: BIRCH STEWART KOLASCH & BIRCH, PO BOX 747, FALLS CHURCH, VA, 22040-0747, US

(21) Appl. No.: 10/108,717

(22) Filed: Mar. 29, 2002

(30) Foreign Application Priority Data
Mar. 30, 2001 (JP) 2001-099108

(51) Int. Cl. H02K 1/06

(52) U.S. Cl. 310/217

(57) ABSTRACT

The invention concerns a method for manufacturing an armature of an internal rotor type electric machine comprising a plurality of stator teeth, coils wound on the stator teeth and a stator yoke on the inner circumference of which the stator teeth are fixed. The stator teeth are attached radially to an outer circumference of a connecting disc, then the coils are wound on the stator teeth, then external edges of the stator teeth are fixed to an inner circumference of the stator yoke and then the connecting disc is removed from the stator teeth.

### BACKGROUND OF THE INVENTION

1. Field of the Invention

The present invention concerns a method for manufacturing an armature of an internal rotor type electric machine being widely used in such as office apparatuses, electronic computer environmental apparatuses, home electric apparatuses, medical care appliances and factory automation machines.

2. Description of the Prior Art

In the prior art, an armature is constructed by winding coils on a plurality of stator magnetic pole teeth formed radially inside of a stator yoke. The winding of the coils is made manually through narrow gaps in the stator core, or by inserting a needle of a winding machine into the gap, or using an inserter. In the case of the manual winding of the coils, there is a problem that the skill is demanded of the operators. In the case of the needle winding machine, there is a problem that the amount of the coils to be wound is limited by the space required for the machine to move. Also in the case of using the inserter, there is still a problem that the space factor of the coils can not be raised.

### SUMMARY OF THE INVENTION

It is an object of the present invention to provide a method for manufacturing an armature of internal rotor type electric machine in which the winding of coils on stator cores can be made easily, that is excellent in production efficiency, by which the space factor can be raised, and that is applicable to such as a brushless motor or a stepping motor that is an internal rotor type electric machine.

It is another object of the present invention to provide an armature of an internal rotor type electric machine manufactured by such method.

To achieve the above objects, the present invention provides a method for manufacturing an armature of an internal rotor type electric machine comprising a plurality of stator teeth, coils wound on the stator teeth and a stator yoke on the inner circumference of which the stator teeth are fixed, wherein the stator teeth are attached radially to an outer circumference of a connecting disc, then the coils are wound on the stator teeth, then external edges of the stator teeth are fixed on the inner circumference of the stator yoke and then the connecting disc is removed from the stator teeth.

Since the coils are wound on the stator teeth prior to be fixed to the stator york, the circumference of the stator teeth is left open, and the winding of the coils can be made easily. Moreover, either of a needle winding machine or a flyer winding machine can be used for winding the coils. Accordingly, armature of an internal rotor type electric machine of which the space factor of the coils and the production efficiency are raised can be provided.

Further, armatures suitable to be applied for such as brushless motors, stepping motors or induction motors that are internal rotor type electric machines can be manufactured by the method for manufacturing an armature of an internal rotor type electric machine according to the present invention.

### BRIEF DESCRIPTION OF THE DRAWINGS

FIG. 1 is a plan view of a star-shaped core according to the present invention.

FIG. 2 is a plan view of a stator yoke according to the present invention.

FIG. 3 is a plan view of a connecting disc according to the present invention.

FIG. 4 is an enlarged partial view of portion C in FIG. 3.

FIG. 5 is a plan view of a stator tooth according to the present invention.

FIG. 6 is a plan view of a laminated star-shaped core according to the present invention.

FIG. 7 is a sectional view of the laminated star-shaped core according to the present invention.

FIG. 8 is a plan view of another stator tooth according to the present invention.

FIG. 9 is an enlarged partial view of a connecting disc for the stator tooth in FIG. 8, according to the present invention.

FIG. 10 is a plan view of further another stator tooth according to the present invention.

FIG. 11 is an enlarged partial view of a connecting disc for the stator tooth in FIG. 10, according to the present invention.

FIG. 12 is a plan view of a laminated stator yoke according to the present invention.

FIG. 13 is a sectional view of the laminated stator yoke according to the present invention.

FIG. 14 is a sectional view of a bobbin coil according to the present invention.

FIG. 15 is a sectional view of a star-shaped core to which the bobbin coils are attached according to the present invention.

FIG. 16 is a sectional view of a star-shaped core to which the bobbin coils are attached and that is connected by the stator yoke according to the present invention.

FIG. 17 is a sectional view of an armature of an internal rotor type electric machine according to the present invention.

### DETAILED DESCRIPTION OF THE INVENTION

Embodiments of the present invention are explained referring to the attached drawings.

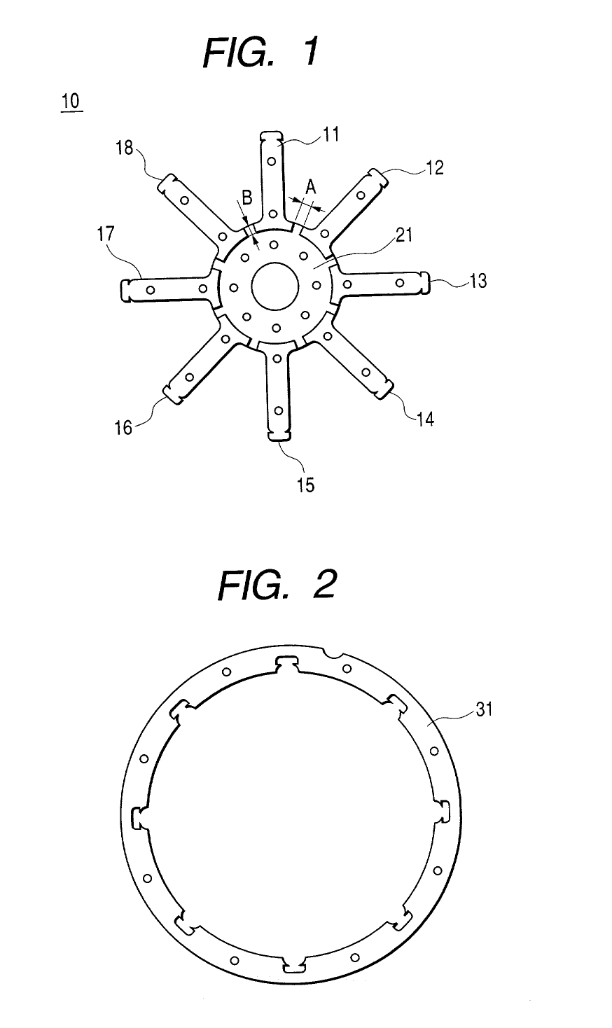

FIG. 1 is a plan view of a star-shaped core 10 for an internal rotor type electric machine according to the present invention. FIG. 2 is a plan view of a stator yoke 31 according to the present invention.

The star-shaped core 10 comprises stator teeth 11 to 18 and a connecting disc 21. Later on, the stator teeth 11 to 18 are connected to the stator yoke 31 to form a stator core.

The star-shaped core 10 and the stator yoke 31 are made by punching and lamination using a press.

Then, an electrical insulation process is applied to the star-shaped core 10. After that, coils are wound on the magnetic pole teeth 11 to 18. Since the circumference of the star-shaped core 10 is opened, winding of the coils can be easily made by a needle winding machine or a flyer winding machine and the space factor of the coils can be raised. Further, bobbins on which coils are wound can also be attached to the magnetic pole teeth 11 to 18 without difficulty.

The star-shaped core 10 on which coils are wound is pushed into an inside of the stator yoke 31 to be connected with the latter. Then, the connecting disc 21 is removed and an armature of an internal rotor type electric machine is completed.

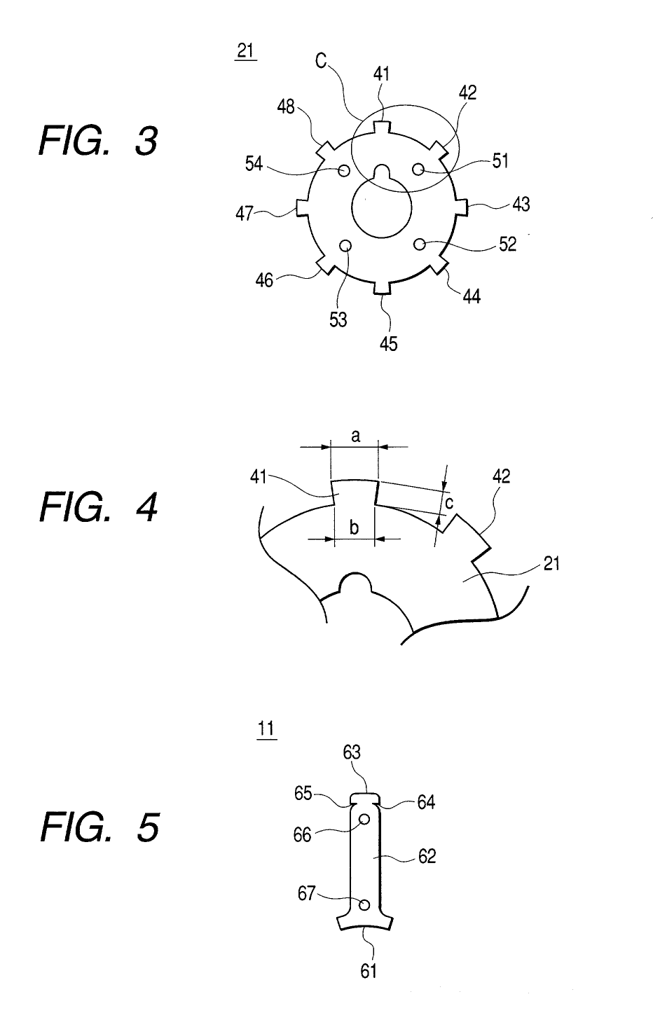

FIG. 3 is a plan view of the connecting disc 21. The connecting disc 21 shown in the figure as an example is provided with eight protruding portions 41 to 48 placed at regular intervals on the circumference. Further, four lamination dowels 51 to 54 are also provided.

FIG. 4 is an enlarged partial view of portion C in FIG. 3. Width a of each of the protruding portions 41 to 48 corresponds to an interval A (see FIG. 1) between two tooth edge portions 61 (see FIG. 5) of the stator teeth 11 to 18. Also, height c of each of the protruding portions 41 to 48 corresponds to a height B (see FIG. 1) of each of the tooth edge portions 61. Additionally, as shown in FIG. 4, the width a at the top of each of the protruding portions 41 to 48 is made larger than the width b at the root of the protruding portions. That is, the width of the protruding portion increases from the root toward the top.

FIG. 5 is a plan view showing in detail an example of the stator tooth 11. The stator tooth 11 comprises a tooth edge portion 61, a magnetic route portion 62 and a yoke connecting portion 63, and provided with holding grooves 64,65 and lamination dowels 66,67.

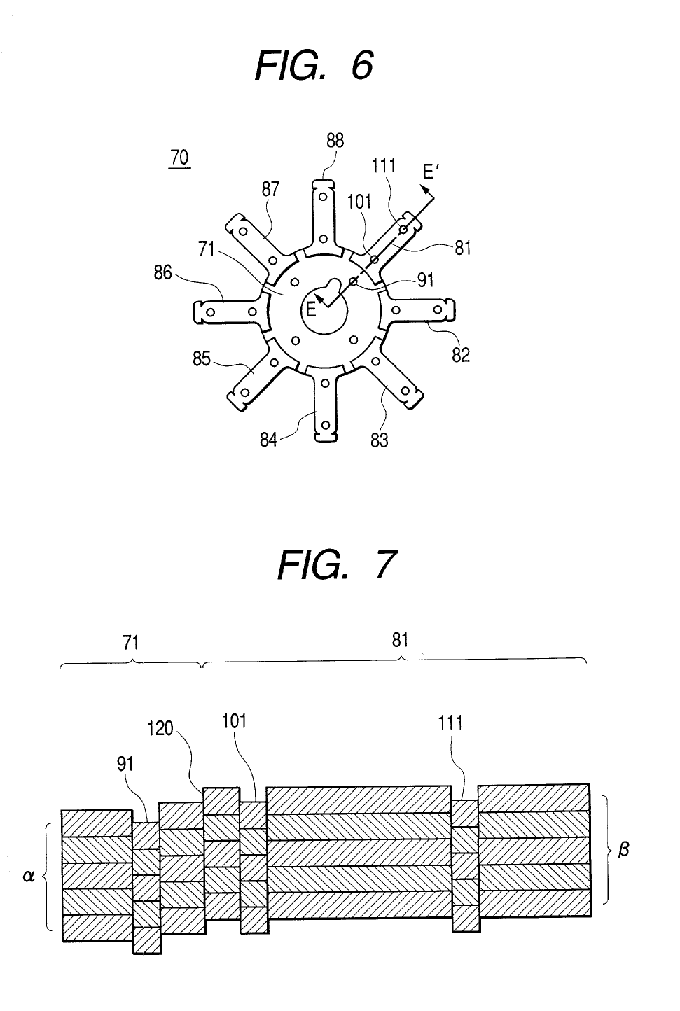

FIG. 6 is a plan view of a laminated star-shaped core 70 according to the present invention. The laminated star-shaped core 70, shown as an example, comprises a laminated connecting disc 71 and eight laminated stator teeth 81 to 88 connected to the laminated connecting disc 71.

The connection of the eight laminated stator teeth 81 to 88 to the laminated connecting disc 71 is made automatically by a punching machine for the stator core. The punching and the lamination are made simultaneously.

The lamination process is carried out as follows.

FIG. 7 is a sectional view of the laminated star-shaped core 70 along E-E′ line shown in FIG. 6. In an example shown in the drawing, five sheets of silicon steel plates a are laminated.

Two adjacent silicon steel plates in five silicon steel plates α composing the laminated connecting disc 71 are laminated with each other by each of five lamination dowels 91 wedged by half thickness of each of the adjacent steel plates.

Also, two adjacent silicon steel plates in five silicon steel plates β composing the laminated stator tooth 81 connected to the external circumference portion of the laminated connecting disc 71 are laminated with each other by each of five lamination dowels 111 also wedged by half thickness of each of the adjacent silicon steel plates.

The stator teeth 82 to 88 are also laminated in the same manner and connected to the external circumference portion of the laminated connecting disc 71.

Form of the tooth edge portion 61 of the stator tooth 11 shown in FIG. 5 as an example differs according to the uses, that is, for an induction motor, for a brushless motor or for a stepping motor.

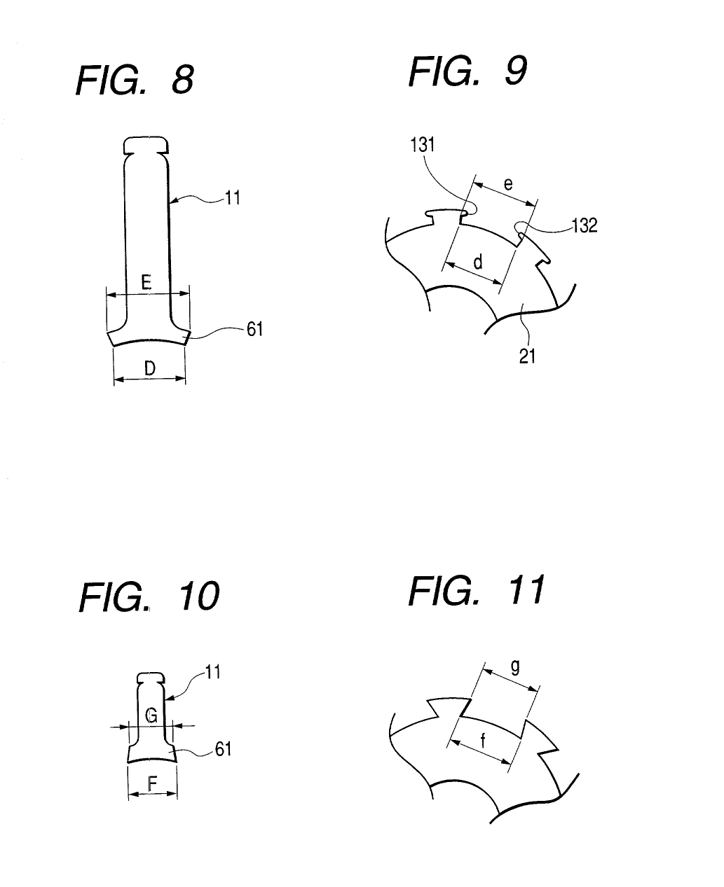

FIG. 8 shows an example of a form of stator tooth for a two-phase induction motor. In general, an inner portion tooth width D is less than an outer tooth width E. In order to connect the stator tooth 11 having such form to the connecting disc 21 with a sufficient connection strength, tooth edge pressing bosses 131, 132, . . . are provided with protruding portions of the connecting disc 21, since an inner connecting width d is less than an outer connecting width e as shown in FIG. 9. When connected, the inner portion tooth width D coincides with the inner connecting width d and the outer tooth width E coincides with the outer connecting width e. Consequently, the laminated stator teeth 81 to 88 as shown in FIG. 6 are not separated outwardly from the laminated connecting disc 71.

FIG. 10 is a plan view of further another stator tooth, in which an inner portion tooth width F is larger than an outer tooth width G. The corresponding form of the connecting disc is shown in FIG. 11, in which an inner connecting width f corresponding to the inner portion tooth width F is larger than an outer connecting width g corresponding to the outer tooth width G. Consequently, the laminated stator teeth 81 to 88 as shown in FIG. 6 are not separated outwardly from the laminated connecting disc 71.

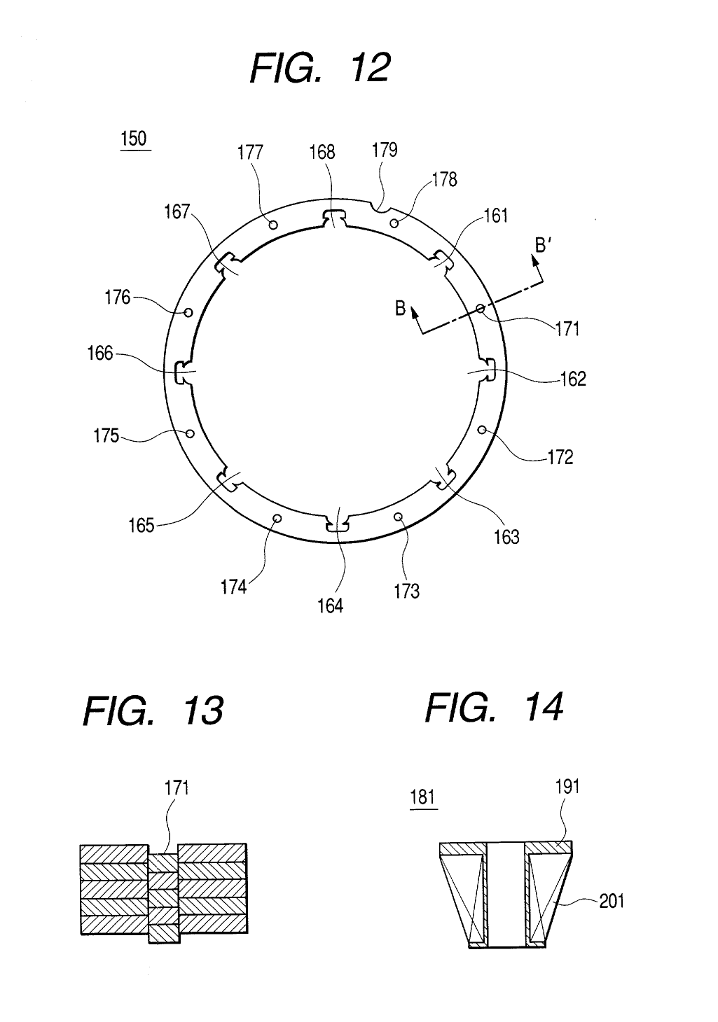

FIG. 12 is a plan view of a laminated stator yoke 150 according to the present invention. In an inner circumferential portion of the laminated stator yoke 150, grooves 161 to 168 for inserting the york connection portions of the laminated stator teeth 81 to 88 are provided. Also, lamination dowels 171 to 178 are provided with the laminated stator yoke 150.

FIG. 13 is a sectional view of the laminated stator yoke along B-B′ line in FIG. 12. Each of five lamination dowels 171 is successively wedged by half thickness of each of adjacent steel plates of the stator yoke by a press machine to laminate the adjacent steel plates. Thus, the stator yoke is laminated.

FIG. 14 is a sectional view of a bobbin coil according to the present invention. Coils 201 are wound on the bobbin coil 191. The bobbin coils 181 of the same number to the laminated stator teeth 81 to 88 are prepared.

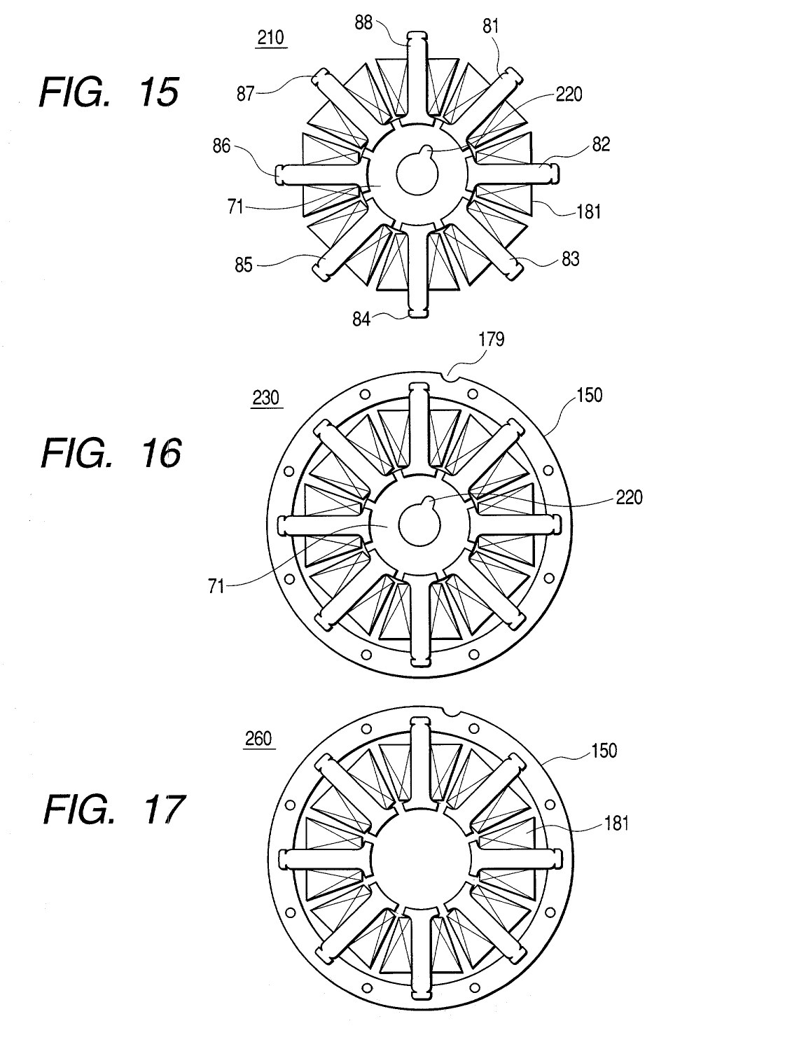

FIG. 15 is a sectional view of a laminated star-shaped core 210 on which the bobbin coils 181 of the same number to the laminated stator teeth 81 to 88 are attached to the laminated stator teeth 81 to 88 as shown in FIG. 6.

Thus, since the circumference of the laminated stator teeth 81 to 88 according to the present invention is left open, the bobbin coils 181 can be attached easily to the laminated stator teeth 81 to 88. Additionally, although the above explanation is made for the case in which the bobbin coils 181 are used, winding of coils directly on the laminated stator teeth 81 to 88 is also can be made easily using either of a needle winding machine or a flyer winding machine. Accordingly, the space factor of the coils, and consequently the power of the motor, can be raised.

FIG. 16 is a sectional view of a laminated stator core 230 connected to the laminated stator yoke 150, according to the present invention. The laminated stator core 230 is formed by pushing the laminated star-shaped core 210, on which the bobbin coils 181 are attached as shown in FIG. 15, into the laminated stator yoke 150 as shown in FIG. 12. The positioning of the laminated star-shaped core 210 with the laminated stator yoke 150 is made using a matchmark 220 formed on the inner circumference of the laminated connecting disc 71 and another matchmark 179 formed on the outer circumference of the laminated stator yoke 150. In this manner, each of the grooves 161 to 168 of the laminated stator yoke 150 perfectly coincides with each of the yoke connecting portions 63 of the laminated stator teeth 81 to 88 and a connection with high accuracy can be made.

FIG. 17 is a sectional view of an armature 260 of an internal rotor type electric machine according to the present invention. The armature 260 is completed by pressing the surface of the laminated connecting disc 71 to remove the laminated connecting disc 71 from the laminated stator core 230 shown in FIG. 16.

In the above description of the embodiment according to the present invention, the explanation is made for a case in which eight stator teeth are formed as an example. It is quite apparent that the number of the teeth is not limited to eight but it can be arbitrary chosen at need. Also, the explanation is made for a case in which five sheets of silicon steel plates are laminated. It is also quite apparent that the number of the silicon steel plates is not limited to five but it can be arbitrary chosen at need.

What is claimed is:

1. A method for manufacturing an armature of an internal rotor type electric machine comprising a plurality of stator teeth, coils wound on said stator teeth and a stator yoke on the inner circumference of which said stator teeth are fixed, wherein said stator teeth are attached radially to an outer circumference of a connecting disc, then said coils are wound on said stator teeth, then external edges of said stator teeth are fixed to an inner circumference of said stator yoke and then said connecting disc is removed from said stator teeth.

2. The method for manufacturing an armature of an internal rotor type electric machine according to claim 1, wherein an inner portion tooth width of said stator tooth to be attached radially to said outer circumference of said connecting disc is smaller than an outer tooth width of said stator tooth.

3. The method for manufacturing an armature of an internal rotor type electric machine according to claim 1, wherein a tooth width of said stator tooth to be attached radially to said outer circumference of said connecting disc is largest at inner end portion of said stator tooth.

4. An armature of an internal rotor type electric machine comprising a plurality of stator teeth, coils wound on said stator teeth and a stator yoke on the inner circumference of which said stator teeth are fixed, wherein said armature is manufactured by attaching said stator teeth radially to an outer circumference of a connecting disc, then winding said coils on said stator teeth, then fixing external edges of said stator teeth on said inner circumference of said stator yoke and then removing said connecting disc from said stator teeth.

5. The armature of an internal rotor type electric machine according to claim 4, wherein an inner portion tooth width of said stator tooth to be attached radially to said outer circumference of said connecting disc is smaller than an outer tooth width of said stator tooth.

6. The armature of an internal rotor type electric machine according to claim 5, wherein a tooth width of said stator tooth to be attached radially to said outer circumference of said connecting disc is largest at inner end portion of said stator tooth.
